(19) United States
(12) Patent Application Publication
(10) Pub. No.: US 2025/0033627 A1
(43) Pub. Date: Jan. 30, 2025

(54) SYSTEM AND METHOD FOR DETERMINING CONNECTION STATUS OF BATTERY SYSTEM OF WORK MACHINE

(71) Applicant: Caterpillar Inc., Peoria, IL (US)

(72) Inventors: Eric Wade Cler, Oswego, IL (US); Elizabeth R.K. Brockman, Charlotte, NC (US)

(73) Assignee: Caterpillar Inc., Peoria, IL (US)

(21) Appl. No.: 18/357,239

(22) Filed: Jul. 24, 2023

(51) Int. Cl. B60W 10/26; B60R 16/033; B60W 50/14; H02J 7/00

(52) U.S. Cl. CPC B60W 10/26; B60R 16/033; B60W 50/14; H02J 7/0032

(57) ABSTRACT

A system for determining a connection status of a battery system of a work machine includes one or more processors configured to detect, based on information from a communication system of the work machine, a key-off event of the work machine and determine, after the key-off event of the work machine, that a device associated with an operator of the work machine has moved away from the work machine by the predetermined distance. The one or more processors are also configured to determine, based on the device being moved away by at least the predetermined distance and based on the device being unable to communicate with the communication system, that the battery system is in a disconnected state and indicate, based on the battery system being in the disconnected state, to the operator that the battery system is in the disconnected state.

### TECHNICAL FIELD

The present disclosure relates to a work machine, and a system and a method for determining a connection status of a battery system of the work machine.

### BACKGROUND

Machines that use battery systems as a source of powering one or more machine components may have to be charged at an end of a work shift/workday, so as to have sufficient power available for performing machine operations during the next work shift/workday. An operator of the machine may toggle the battery system to a disconnected state before moving away from the machine, in order to prevent draining of the battery system. In some situations, the operator may key-off the machine and connect a battery charger, but may also disconnect the battery system out of habit. If the battery system is in the disconnected state, the battery system may not get charged by the battery charger, and may not be able to work during the next work shift/workday.

U.S. Pat. No. 10,611,258 describes a vehicle including a low-voltage battery, a high-voltage battery, and a converter that decreases voltage provided from the high-voltage battery to the low-voltage battery. A system controller of the vehicle is programmed to use the converter, in a key-off cycle, to charge the low-voltage battery a calibrated number of times that the low-voltage battery drops below a predefined state-of-charge threshold, and send a wireless notification a subsequent time the low-voltage battery drops below the threshold. A notification is sent to a predefined contact address when a periodically computed state of charge of a low-voltage battery of a vehicle falls below a predefined threshold. Using a converter, voltage provided from a high-voltage battery of the vehicle to the low-voltage battery is decreased to charge the low-voltage battery responsive to receipt from the contact address of a response indicating approval of the charge.

### SUMMARY OF THE DISCLOSURE

In an aspect of the present disclosure, a system for determining a connection status of a battery system of a work machine is provided. The system includes one or more memories configured to store a predetermined distance. The system also includes one or more processors communicably coupled to the one or more memories. The one or more processors are configured to detect, based on information from a communication system of the work machine, a key-off event of the work machine. The one or more processors are also configured to determine, after the key-off event of the work machine, that a device associated with an operator of the work machine has moved away from the work machine by the predetermined distance. The one or more processors are further configured to determine, based on the device being moved away by at least the predetermined distance and based on the device being unable to communicate with the communication system, that the battery system is in a disconnected state. The one or more processors are configured to indicate, based on the battery system being in the disconnected state, to the operator that the battery system is in the disconnected state.

In another aspect of the present disclosure, a work machine is provided. The work machine includes a battery system configured to provide operating power to one or more components of the work machine. The battery system is switchable between a connected state and a disconnected state. The battery system is connectable with a charging system. The battery system is chargeable by the charging system when the battery system is in the connected state and the battery system is not chargeable by the charging system when the battery system is in the disconnected state. The work machine also includes a communication system configured to indicate a key-off event of the work machine. The work machine further includes a system for determining a connection status of the battery system. The system includes one or more memories configured to store a predetermined distance. The system also includes one or more processors communicably coupled to the one or more memories. The one or more processors are configured to detect, based on information from a communication system of the work machine, a key-off event of the work machine. The one or more processors are also configured to determine, after the key-off event of the work machine, that a device associated with an operator of the work machine has moved away from the work machine by the predetermined distance. The one or more processors are further configured to determine, based on the device being moved away by at least the predetermined distance and based on the device being unable to communicate with the communication system, that the battery system is in a disconnected state. The one or more processors are configured to indicate, based on the battery system being in the disconnected state, to the operator that the battery system is in the disconnected state. The indication to the operator is provided via the device.

In another aspect of the present disclosure, a method of determining a connection status of a battery system of a work machine is provided. The method includes detecting, by one or more processors, based on information from a communication system of the work machine, a key-off event of the work machine. The method includes determining, by the one or more processors, after the key-off event of the work machine, that a device associated with an operator of the work machine has moved away from the work machine by a predetermined distance. The method also includes determining, by the one or more processors, based on the device being moved away by at least the predetermined distance and based on the device being unable to communicate with the communication system, that the battery system is in a disconnected state. The method further includes indicating, by the one or more processors, based on the battery system being in the disconnected state, to the operator that the battery system is in the disconnected state.

Other features and aspects of this disclosure will be apparent from the following description and the accompanying drawings.

### BRIEF DESCRIPTION OF THE DRAWINGS

FIG. 1 is a schematic side view of a work machine, according to an embodiment of the present disclosure;

FIG. 2 is a block diagram of a system for determining a connection status of a battery system of the work machine of FIG. 1, according to an embodiment of the present disclosure;

FIG. 3 is a schematic diagram illustrating communication between the work machine and a device associated with an operator of the work machine of FIG. 1, according to an embodiment of the present disclosure;

FIG. 4 is a flowchart depicting a process for determining the connection status of the battery system of the work machine of FIG. 1, according to an embodiment of the present disclosure; and

FIG. 5 is a flowchart depicting a method for determining the connection status of the battery system of the work machine of FIG. 1, according to an embodiment of the present disclosure.

### DETAILED DESCRIPTION

Wherever possible, the same reference numbers will be used throughout the drawings to refer to the same or like parts.

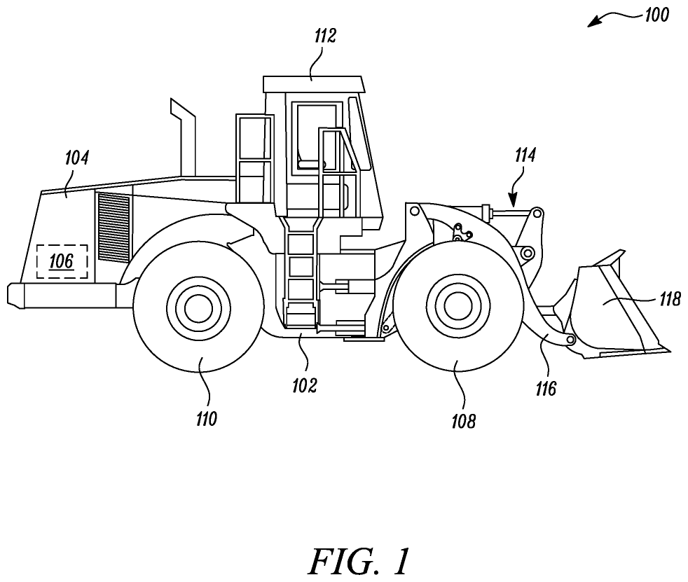

Referring to FIG. 1, a schematic side view of an exemplary work machine 100 is illustrated. The work machine 100 is embodied as a wheel loader that may be used in industries, such as, construction, landscaping, agriculture, and the like. Alternatively, the work machine 100 may be embodied as a mining truck, a dozer, a forklift, an excavator, a track-type tractor, a motor grader, and the like that may be used in various industries to perform one or more work operations.

The work machine 100 includes a frame 102 that supports various components of the work machine 100. The work machine 100 also includes a hood 104 mounted on the frame 102. Further, the work machine 100 includes a prime mover 106 supported by the frame 102. The prime mover 106 may be disposed within the hood 104. The prime mover 106 may provide power to various components of the work machine 100 for operational and mobility requirements. The prime mover 106 may include a battery module, a fuel cell, and/or an engine. In some examples, the battery module may embody a high-voltage battery system and may include one or more battery cells, such as, lithium titanate battery cells to provide operational power to the work machine 100. The fuel cell may include, for example, a hydrogen fuel cell. The engine may include, for example, an internal combustion engine.

The work machine 100 includes a pair of front wheels 108 and a pair of rear wheels 110. The front wheels 108 and the rear wheels 110 provide support and mobility to the work machine 100 on grounds. In other examples, the work machine 100 may include two or more pairs of front wheels 108 and/or the rear wheels 110. Alternatively, the work machine 100 may include tracks or drums instead of the wheels 108, 110.

Further, the work machine 100 includes an operator cabin 112 supported by the frame 102. The operator cabin 112 may include one or more input modules/output modules that may enable an operator to control the work machine 100. The work machine 100 also includes a linkage assembly 114 coupled to the frame 102. The linkage assembly 114 is movably coupled to the frame 102. The linkage assembly 114 includes a pair of linkage arms 116 coupled to the frame 102 at one end thereof. The linkage assembly 114 further includes a work tool 118. The work tool 118 may be used to perform the one or more work operations. The work tool 118 is embodied as a bucket herein. Alternatively, the work tool 118 may be any other type of work tool known in the art, such as, a blade, a fork, a payload carrier that may be raised or lowered, and the like, without any limitations thereto.

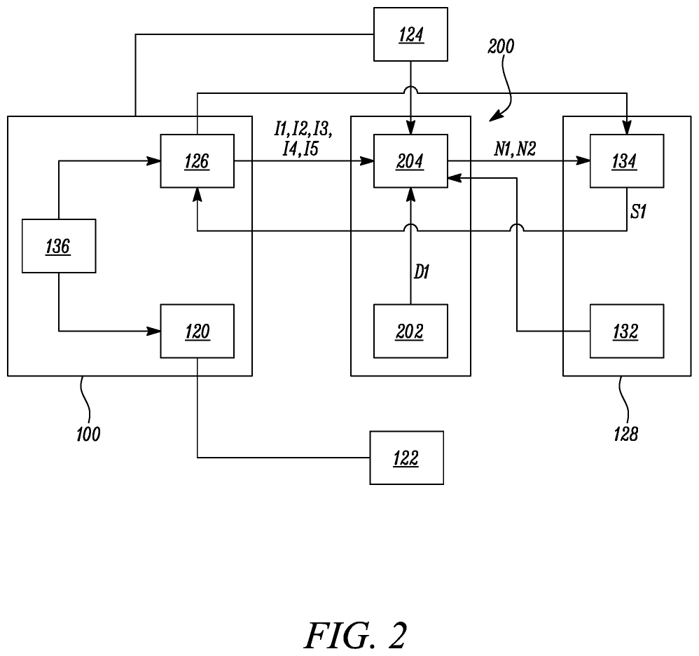

Referring to FIG. 2, the work machine 100 includes a battery system 120 to provide operating power to one or more components of the work machine 100. The battery system 120 may include a low-voltage battery system. The one or more components may include, for example, headlights, door actuators, and/or other electrical systems of the work machine 100. In some examples, power from the battery system 120 may be used to actuate closure of electrical contacts that connect the battery module of the work machine 100 to a powertrain of the work machine 100. In some situations, if the battery system 120 is discharged, the work machine 100 may be unable to move.

The battery system 120 is switchable between a connected state and a disconnected state. The battery system 120 is connectable with a charging system 122. For example, the battery system 120 may be connected to the charging system 122 at an end of a workday or a work shift. Further, the battery system 120 is chargeable by the charging system 122 when the battery system 120 is in the connected state and the battery system 120 is not chargeable by the charging system 122 when the battery system 120 is in the disconnected state.

Further, a first position sensing device 124 is associated with the work machine 100. The first position sensing device 124 may be mounted on the work machine 100 or may be external to the work machine 100. The first position sensing device 124 may generate a position signal indicative of a position of the work machine 100. The first position sensing device 124 may include a global positioning system (GPS), without any limitations.

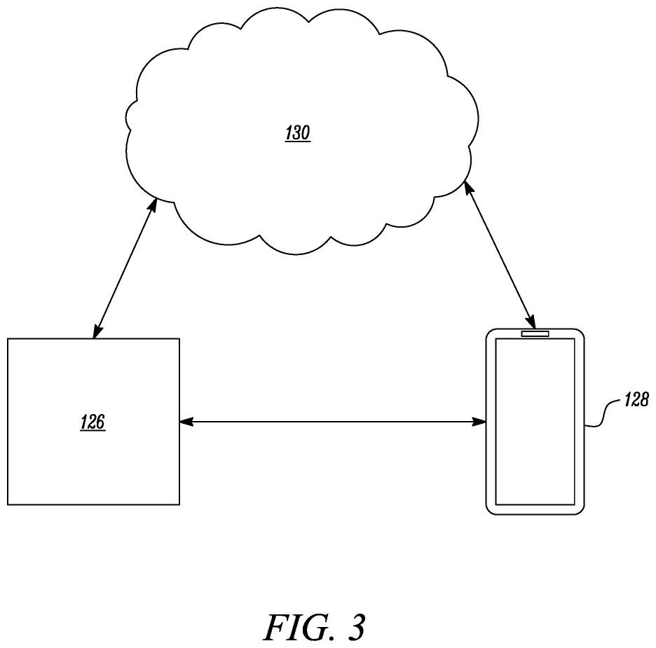

The work machine 100 further includes a communication system 126. The communication system 126 indicates a key-off event of the work machine 100. As shown in FIG. 3, the communication system 126 is in communication with a device 128 associated with the operator. Further, the communication system 126 is also in communication with a cloud system 130. In an example, the communication system 126 may be in direct communication with the device 128. Alternatively, the communication system 126 may be in direct communication with the device 128 via the cloud system 130. The communication system 126 may make use of cellular connection, Bluetooth, WIFI, or any other wireless means to establish desired communication between different systems/devices.

Referring again to FIG. 2, it should be noted that when the battery device 128 is in the connected state, the communication device 128 is in an active state and may continue to transmit/receive information related to the work machine 100. Further, when the battery device 128 is in the disconnected state, the communication device 128 is in an inactive state and may not transmit/receive any information.

The device 128 associated with the operator may include a handheld device. For example, the device 128 may include a cell phone or a tablet. Alternatively, the device 128 may include any other Input/Output device known in the art, without any limitations. The device 128 includes a second position sensing device 132. The second position sensing device 132 may generate a position signal indicative of a position of the device 128. The second position sensing device 132 may include the GPS, without any limitations. Further, the device 128 associated with the operator includes a software application 134. In an example, the software application 134 may be compatible with various operating systems.

The work machine 100 also includes a battery switch 136. The battery system 120 is switchable between the disconnected state and the connected state based on a position of the battery switch 136. The battery switch 136 may be disposed outside of the work machine 100 proximate to stairs that lead to the operator cabin 112 (see FIG. 1). The operator may toggle the battery switch 136 to switch the battery system 120 to the disconnected state before walking away from the work machine 100 after the key-off event of the work machine 100.

The present disclosure relates to a system 200 for determining a connection status of the battery system 120 of the work machine 100. In general, the system 200 may be part of, or attached to, the work machine 100 or the device 128 or may be separate from both the work machine 100 and the device 128. The system 200 includes one or more memories 202 to store a predetermined distance D1. The memories 202 may include any means of storing information, including a hard disk, an optical disk, a floppy disk, ROM (read only memory), RAM (random access memory), PROM (programmable ROM), EEPROM (electrically erasable PROM), and/or other computer-readable memory media. For example, the memories 202 may store data, such as, software applications, algorithms, instructions, and arithmetic operations.

The system 200 also includes one or more processors 204 communicably coupled to the one or more memories 202. The processors 204 may execute various types of digitally stored instructions, such as, software applications or algorithms, retrieved from the memories 202, or a firmware program which may enable the processors 204 to perform a wide variety of operations.

It should be noted that the one or more processors 204 may embody a single microprocessor or multiple microprocessors for receiving various input signals and generating output signals. Numerous commercially available microprocessors may perform the functions of the one or more processors 204. Each processor 204 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor 204 may include one or more components that may be operable to execute computer executable instructions or computer code that may be stored and retrieved from the one or more memories 202.

In some examples, the one or more memories 202 and the one or more processors 204 may be associated with a controller (not shown). In some examples, the one or more memories 202 and the one or more processors 204 may be disposed within the device 128. In the example wherein the memories 202 are disposed in the device 128, the memories 202 may store the software application 134 therein. In the example wherein the processors 204 are disposed in the device 128, the processors 204 may retrieve and execute the software application 134. Alternatively, the one or more memories 202 and the one or more processors 204 may be external to the device 128.

The one or more processors 204 are also communicably coupled to the communication system 126 and the cloud system 130. In one example, the processors 204 may be in direct communication with the communication system 126 of the work machine 100 to receive various information related to the work machine 100, such as, via Bluetooth. In another example, the processors 204 may be in communication with the communication system 126 of the work machine 100 via the cloud system 130.

Further, when the key-off event occurs, the communication system 126 transmits an information I1 to the processors 204. In addition to the information I1 indicating the key-off event, the communication system 126 may also send other indications to the processors 204. In an example, the communication system 126 may transmit an indication I2 that the work machine 100 is scheduled for charging. In another example, the communication system 126 may transmit an indication 13 that a last reported charge of the battery system 120 is below a threshold charge. In yet another example, the communication system 126 may transmit an indication 14 that a last reported location of the work machine 100 is within a threshold distance of the charging system 122 associated with the work machine 100. Additionally, the communication system 126 may provide other indications, for example, the last reported location of the work machine 100, end of a work shift, or any other information that would indicate that the battery system 120 needs to be charged. The communication system 126 may also transmit an indication I5 that the battery system 120 is already connected to the charging system 122.

The one or more processors 204 may receive the information I1 and the various indications I2, I3, I4, I5 directly from the communication system 126 or via the cloud system 130. In some examples, the communication system 126 may also transmit the various indications I2, I3, I4, I5 to the software application 134 on the device 128 with the operator. The software application 134 may receive the information I1 and the indications I2, I3, I4, I5 directly from the communication system 126. Alternatively, the software application 134 may receive the information I1 and the indications I2, I3, I4, I5 via the cloud system 130.

Referring to FIG. 2, the one or more processors 204 detect, based on the information I1 from the communication system 126 of the work machine 100, the key-off event of the work machine 100. Further, after the key-off event of the work machine 100, the processors 204 determine that the device 128 associated with the operator of the work machine 100 has moved away from the work machine 100 by the predetermined distance D1. In order to determine that the device 128 has moved away from the work machine 100 by the predetermined distance D1, the one or more processors 204 determine the last reported location of the work machine 100 after the key-off event. The processors 204 may receive the last reported location of the work machine 100 from the communication system 126 or directly from the first position sensing device 124. Further, the one or more processors 204 also determine a current position of the device 128. The current position of the device 128 may be received from the second position sensing device 132. Further, the one or more processors 204 compare the last reported location of the work machine 100 with the current position of the device 128. If a distance between the last reported location of the work machine 100 and the current position of the device 128 is greater than the predetermined distance D1, the processors 204 determine that the device 128 has moved away from the work machine 100 by the predetermined distance D1.

Further, the one or more processors 204 determines that the device 128 is unable to communicate with the communication system 126. For this purpose, the one or more processors 204 transmit, from the device 128, one or more communication signals S1 to the communication system 126 of the work machine 100. In an example, the one or more communication signals S1 may be sent to the communication system 126 via the software application 134. The one or more processors 204 also detect, at the device 128, that the communication system 126 is unable to receive a communication signal S1 of the one or more communication signals S1. Further, the communication system 126 receives the one or more communication signals S1 only when the battery system 120 is in the connected state. In an example, if the communication system 126 sends a response signal to the device 128, the processors 204 determine that the communication system 126 is in the active state and if the communication system 126 does not send any response signal to the device 128, the processors 204 determine that the communication system 126 is in the inactive state.

Further, the one or more processors 204 determine, based on the device 128 being moved away by at least the predetermined distance D1 and based on the device 128 being unable to communicate with the communication system 126, that the battery system 120 is in the disconnected state. Thus, if the communication system 126 is unable to receive the communication signals S1, the processors 204 determine that the communication system 126 is in the inactive state and the battery system 120 is in the disconnected state.

Further, the one or more processors 204 indicate, based on the battery system 120 being in the disconnected state, to the operator that the battery system 120 is in the disconnected state. The indication to the operator is provided via the device 128. In order to indicate that the battery system 120 is in the disconnected state, the one or more processors 204 alert the operator that the battery system 120 is in the disconnected state via the software application 134 running on the device 128. Specifically, the processors 204 may transmit a first notification N1 to alert the operator that the battery system 120 is in the disconnected state via the software application 134. The first notification N1 may include a text message, an audio message, and the like.

It should be noted that, in order to generate the first notification N1, the one or more processors 204 determine if the battery system 120 is to be charged. Thus, the one or more processors 204 also determine if the battery system 120 is to be charged. In an example, the one or more processors 204 determine that the battery system 120 is to be charged based on the indication 13 that the last reported charge of the battery system 120 is below the threshold charge. The indication 13 is received from the communication system 126.

In another example, the one or more processors 204 determine that the battery system 120 is to be charged based on the indication 14 that the last reported location of the work machine 100 is within the threshold distance of the charging system 122 associated with the work machine 100. The indication 14 is received from the communication system 126. In yet another example, the one or more processors 204 determine that the battery system 120 is to be charged based on the indication I2 that the work machine 100 is scheduled to be charging. The indication 12 is received from the communication system 126. If the processors 204 determine that the battery system 120 needs charging and the charging system 122 is not connected to the battery system 120, the processors 204 generate a second notification N2 to alert the operator that the battery system 120 needs to be charged. The processors 204 transmit the second notification N2 via the software application 134 running on the device 128. The second notification N2 may include a text message, an audio message, and the like. Thus, the first and second notifications N1, N2 are generated only when the battery system 120 needs charging.

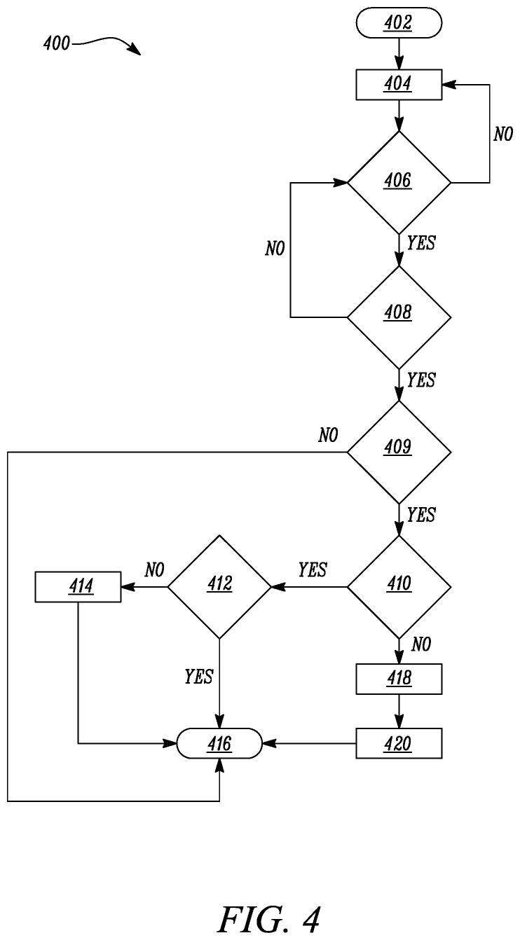

FIG. 4 is an exemplary flowchart depicting an exemplary process (or algorithm) 400 for determining the connection status of the battery system 120 of the work machine 100. The process 400 may be stored in the memories 202 and retrieved for execution by the processors 204. At a block 402, the processors 204 begin operation. At a block 404, the processors 204 receive the information I1 and the indications 12, 13, 14 from the communication system 126. At a block 406, the processors 204 determine if the key-off event of the work machine 100 has occurred based on the information I1 received from the communication system 126. If the processors 204 determine that the key-off event has not occurred, the process 400 moves back to the block 404. However, if the processors 204 determine that the key-off event has occurred, the process 400 moves to a block 408.

At the block 408, the processors 204 determine if the device 128 has moved away from the work machine 100 by the predetermined distance D1 based on the comparison of the last reported location of the work machine 100 with the current position of the device 128. If the processors 204 determine that the device 128 has not moved away from the work machine 100 by the predetermined distance D1, the process 400 moves to the block 406. However, if the processors 204 determine that the device 128 has moved away from the work machine 100 by the predetermined distance D1, the process 400 moves to a block 409. At the block 409, the processors 204 determine if the battery system 120 needs charging. The processors 204 determine if the battery system 120 needs charging based on the indications 12, 13, 14. If the battery system 120 does not need charging, the process 400 moves to a block 416 where the process 400 terminates operation. However, if the processors 204 determine that the battery system 120 needs charging, the process 400 moves to a block 410.

At the block 410, the processors 204 determine if the device 128 is able to communicate with the communication system 126. Specifically, the processors 204 transmit the one or more communication signals S1 to the communication system 126 via the device 128. If the processors 204 determine that the communication system 126 has received one or more of the communication signals S1, the processors 204 determine that the communication signal S1 is in the active state and moves to a block 412. At the block 412, the processors 204 determine if the charging system 122 is connected to the battery system 120 based on the indication I5 received from the communication system 126. If the processors 204 determine that the charging system 122 is not connected to the battery system 120 even if the battery system 120 needs charging, the process 400 moves to a block 414. At the block 414, the processors 204 generate the second notification N2 to alert the operator that the battery system 120 needs to be charged. The process 400 then moves to the block 416 where the process 400 terminates operation. However, at the block 412, if the processors 204 determine that the charging system 122 is connected to the battery system 120, the process 400 moves to the block 416 where the process 400 terminates operation.

However, at the block 410, if the processors 204 determine that the communication system 126 has not received the communication signal S1, the processors 204 determine that the communication system 126 is in the inactive state and the process 400 moves to a block 418. At the block 418, the processors 204 determine that the battery system 120 is in the disconnected state. The process 400 further moves to a block 420 to generate the first notification N1 to indicate to the operator that the battery system 120 is in the disconnected state via the device 128. From the block 420, the process 400 moves to the block 416 at which the process 400 terminates operation.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the system 200 for alerting the operator if the battery system 120 is in the disconnected state. In situation wherein the operator of the work machine 100 may toggle the battery system 120 to the disconnected state after the end of the workday or the work shift, the system 200 determines that the battery system 120 is in the disconnected state and accordingly alerts the operator via the device 128 present with the operator regarding the disconnected state of the battery system 120. The operator may accordingly take measures to switch the battery system 120 to the connected state to charge the battery system 120.

Further, if the system 200 determines that the charging system 122 is not connected to the battery system 120 even when the battery system 120 requires charging, the system 200 alerts the operator that the battery system 120 is not charging. Accordingly, the operator may take required measures to connect the battery system 120 with the charging system 122. Thus, the system 200 described herein may ensure that the battery system 120 is being charged when the work machine 100 is not in operation, thereby allowing usage of the work machine 100 during the next work shift or workday. Further, the system 200 described herein may be retrofitted to use with existing work machines, and may provide a simple and cost-effective technique of ensuring that the battery system 120 is not in the disconnected state and that the battery system 120 is charging.

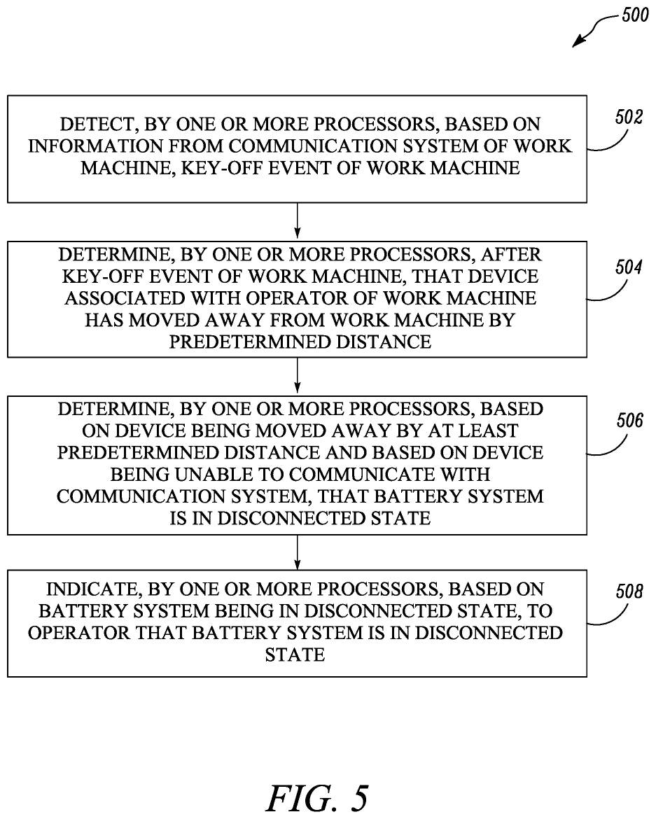

Referring to FIG. 5, a flowchart of a method 500 for determining the connection status of the battery system 120 of the work machine 100 is illustrated. The battery system 120 includes the low-voltage battery system. At step 502, the one or more processors 204 detect the key-off event of the work machine 100 based on the information I1 from the communication system 126 of the work machine 100. At step 504, the one or more processors 204 determine that the device 128 associated with the operator of the work machine 100 has moved away from the work machine 100 by the predetermined distance D1 after the key-off event of the work machine 100.

At step 506, the one or more processors 204 determine that the battery system 120 is in the disconnected state based on the device 128 being moved away by at least the predetermined distance D1 and based on the device 128 being unable to communicate with the communication system 126.

In order to determine that the device 128 is unable to communicate with the communication system 126, the one or more processors 204 transmit the one or more communication signals S1 to the communication system 126 of the work machine 100 from the device 128. Further, the one or more processors 204 detect that the communication system 126 is unable to receive the communication signal S1 of the one or more communication signals S1 at the device 128. The communication system 126 receives the one or more communication signals S1 only when the battery system 120 is in the connected state. Further, the battery system 120 is chargeable by the charging system 122 when the battery system 120 is in the connected state. Moreover, the battery system 120 is not chargeable by the charging system 122 when the battery system 120 is in the disconnected state.

Further, in order to determine that the device 128 has moved away from the work machine 100 by the predetermined distance D1, the one or more processors 204 determine the last reported location of the work machine 100 after the key-off event. The one or more processors 204 also determine the current position of the device 128. Further, the one or more processors 204 compare the last reported location of the work machine 100 with the current position of the device 128.

At step 508, the one or more processors 204 indicate to the operator that the battery system 120 is in the disconnected state based on the battery system 120 being in the disconnected state. The one or more processors 204 indicate to the operator that the battery system 120 is in the disconnected state via the software application 134 running on the device 128.

Further, the method 500 also includes a step where the one or more processors 204 determine that the battery system 120 is to be charged based on the indication 13 that the last reported charge of the battery system 120 is below the threshold charge, the indication 14 that the last reported location of the work machine 100 is within the threshold distance of the charging system 122 associated with the work machine 100, or the indication I2 that the work machine 100 is scheduled to be charging.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of the disclosure. Such embodiments should be understood to fall within the scope of the present disclosure as determined based upon the claims and any equivalents thereof.

What is claimed is:

1. A system for determining a connection status of a battery system of a work machine, the system comprising:
one or more memories configured to store a predetermined distance; and
one or more processors communicably coupled to the one or more memories, the one or more processors are configured to:
detect, based on information from a communication system of the work machine, a key-off event of the work machine;
determine, after the key-off event of the work machine, that a device associated with an operator of the work machine has moved away from the work machine by the predetermined distance;
determine, based on the device being moved away by at least the predetermined distance and based on the device being unable to communicate with the communication system, that the battery system is in a disconnected state; and
indicate, based on the battery system being in the disconnected state, to the operator that the battery system is in the disconnected state.

2. The system of claim 1, wherein the one or more processors are further configured to determine that the battery system is to be charged based on at least one of:
an indication that a last reported charge of the battery system is below a threshold charge;
an indication that a last reported location of the work machine is within a threshold distance of a charging system associated with the work machine; and
an indication that the work machine is scheduled to be charging.

3. The system of claim 1, wherein the one or more processors, to indicate that the battery system is in the disconnected state, are configured to:
alert the operator that the battery system is in the disconnected state via a software application running on the device.

4. The system of claim 1, wherein the one or more processors, to determine that the device is unable to communicate with the communication system, are configured to:
transmit, from the device, one or more communication signals to the communication system of the work machine; and
detect, at the device, that the communication system is unable to receive a communication signal of the one or more communication signals,
wherein the communication system is configured to receive the one or more communication signals only when the battery system is in a connected state,
wherein the battery system is chargeable by a charging system when the battery system is in the connected state, and
wherein the battery system is not chargeable by the charging system when the battery system is in the disconnected state.

5. The system of claim 1, wherein the one or more processors, to determine that the device has moved away from the work machine by the predetermined distance, are configured to:
determine a last reported location of the work machine after the key-off event;
determine a current position of the device; and
compare the last reported location of the work machine with the current position of the device.

6. The system of claim 1, wherein the battery system includes a low-voltage battery system.

7. The system of claim 1, wherein the work machine further includes a battery switch, and wherein the battery system is switchable between the disconnected state and a connected state based on a position of the battery switch.

8. A work machine comprising:
a battery system configured to provide operating power to one or more components of the work machine, wherein the battery system is switchable between a connected state and a disconnected state, wherein the battery system is connectable with a charging system, and wherein the battery system is chargeable by the charging system when the battery system is in the connected state and the battery system is not chargeable by the charging system when the battery system is in the disconnected state;
a communication system configured to indicate a key-off event of the work machine; and
a system for determining a connection status of the battery system, the system including:
one or more memories configured to store a predetermined distance; and
one or more processors communicably coupled to the one or more memories, the one or more processors are configured to:
detect, based on information from a communication system of the work machine, a key-off event of the work machine;
determine, after the key-off event of the work machine, that a device associated with an operator of the work machine has moved away from the work machine by the predetermined distance;
determine, based on the device being moved away by at least the predetermined distance and based on the device being unable to communicate with the communication system, that the battery system is in a disconnected state; and
indicate, based on the battery system being in the disconnected state, to the operator that the battery system is in the disconnected state, wherein the indication to the operator is provided via the device.

9. The work machine of claim 8, wherein the one or more processors are further configured to determine that the battery system is to be charged based on at least one of:
an indication that a last reported charge of the battery system is below a threshold charge;
an indication that a last reported location of the work machine is within a threshold distance of the charging system associated with the work machine; and
an indication that the work machine is scheduled to be charging.

10. The work machine of claim 8, wherein the one or more processors, to indicate that the battery system is in the disconnected state, are configured to:
alerting the operator that the battery system is in the disconnected state via a software application running on the device.

11. The work machine of claim 8, wherein the one or more processors, to determine that the device is unable to communicate with the communication system, are configured to:
transmit, from the device, one or more communication signals to the communication system of the work machine; and
detect, at the device, that the communication system is unable to receive a communication signal of the one or more communication signals,
wherein the communication system is configured to receive the one or more communication signals only when the battery system is in the connected state,
wherein the battery system is chargeable by the charging system when the battery system is in the connected state, and
wherein the battery system is not chargeable by the charging system when the battery system is in the disconnected state.

12. The work machine of claim 8, wherein the one or more processors, to determine that the device has moved away from the work machine by the predetermined distance, are configured to:
determine a last reported location of the work machine after the key-off event;
determine a current position of the device; and
compare the last reported location of the work machine with the current position of the device.

13. The work machine of claim 8, wherein the battery system includes a low-voltage battery system.

14. The work machine of claim 8, wherein the work machine further includes a battery switch, and wherein the battery system is switchable between the disconnected state and the connected state based on a position of the battery switch.

15. A method of determining a connection status of a battery system of a work machine, the method comprising:
detecting, by one or more processors, based on information from a communication system of the work machine, a key-off event of the work machine;
determining, by the one or more processors, after the key-off event of the work machine, that a device associated with an operator of the work machine has moved away from the work machine by a predetermined distance;
determining, by the one or more processors, based on the device being moved away by at least the predetermined distance and based on the device being unable to communicate with the communication system, that the battery system is in a disconnected state; and
indicating, by the one or more processors, based on the battery system being in the disconnected state, to the operator that the battery system is in the disconnected state.

16. The method of claim 15, further comprising determining, by the one or more processors, that the battery system is to be charged based on at least one of:
an indication that a last reported charge of the battery system is below a threshold charge;
an indication that a last reported location of the work machine is within a threshold distance of a charging system associated with the work machine; and
an indication that the work machine is scheduled to be charging.

17. The method of claim 15, wherein the step of indicating to the operator that the battery system is in the disconnected state further includes:
alerting, by the one or more processors, the operator that the battery system is in the disconnected state via a software application running on the device.

18. The method of claim 15, wherein the step of determining that the device is unable to communicate with the communication system further includes:
transmitting, by the one or more processors, one or more communication signals to the communication system of the work machine from the device; and
detecting, by the one or more processors, that the communication system is unable to receive a communication signal of the one or more communication signals at the device,
wherein the communication system is configured to receive the one or more communication signals only when the battery system is in a connected state,
wherein the battery system is chargeable by a charging system when the battery system is in the connected state, and
wherein the battery system is not chargeable by the charging system when the battery system is in the disconnected state.

19. The method of claim 15, wherein the step of determining that the device has moved away from the work machine by the predetermined distance further includes:
determining, by the one or more processors, a last reported location of the work machine after the key-off event;
determining, by the one or more processors, a current position of the device; and
comparing, by the one or more processors, the last reported location of the work machine with the current position of the device.

20. The method of claim 15, wherein the battery system includes a low-voltage battery system.
